(19) United States
(12) Patent Application Publication
(10) Pub. No.: US 2007/0212271 A1
(43) Pub. Date: Sep. 13, 2007

(54) Process air desulfurization for syngas production

(76) Inventors: Paul E. Kennedy, Tulsa, OK (US); Stephen C. LeViness, Tulsa, OK (US); Kenneth L. Agee, Bixby, OK (US); Kym B. Arcuri, Tulsa, OK (US)

Correspondence Address: NIXON PEABODY LLP, 161 N. CLARK STREET, 48TH FLOOR, CHICAGO, IL, 60601-3213, US

(21) Appl. No.: 11/707,410

(22) Filed: Feb. 16, 2007

Related U.S. Application Data
(60) Provisional application No. 60/774,444, filed on Feb. 17, 2006.

(51) Int. Cl. B01D 53/34

(52) U.S. Cl. 422/177

(57) ABSTRACT

A system and method for removing sulfur contaminants from an air stream prior to feeding the air stream to an autothermal reformer. The system includes an air inlet, a first desulfurization reactor, and the autothermal reformer. The air inlet is adapted to allow atmospheric air to enter therethrough to form the air stream. The first desulfurization reactor includes a first fixed bed. The first fixed bed includes one or more metal oxides adapted to remove sulfur dioxide from the air stream to create a desulfurized air stream. The sulfur dioxide is removed from the air stream as the air stream moves through the first desulfurization reactor. The autothermal reformer is adapted to receive the desulfurized air stream and a desulfurized natural gas/steam stream and convert the received desulfurized air stream and the received desulfurized natural gas/steam stream into a synthesis gas stream substantially free of sulfur contaminants.

### CROSS-REFERENCE TO RELATED APPLICATION

This application claims the benefit of U.S. Provisional Application No. 60/774,444, filed Feb. 17, 2006, which is hereby incorporated by reference in its entirety.

### FIELD OF THE INVENTION

This invention relates to a process for reducing contaminants in feed streams used to generate a synthesis gas (syngas) to be used in a Fischer-Tropsch process. More particularly, this invention relates to a process for removing sulfur contaminants from a process air stream used to generate the syngas.

### BACKGROUND OF THE INVENTION

In the Fischer-Tropsch process, a syngas—composed primarily of hydrogen gas and carbon monoxide—is reacted in the presence of a Fischer-Tropsch catalyst to produce heavier hydrocarbons. Fischer-Tropsch catalysts include, for example, cobalt, iron, and ruthenium as well as other Group VIIIB transition metals or combinations of such metals. The Fischer-Tropsch catalysts can be utilized to prepare both saturated and unsaturated hydrocarbons. As is generally understood, these catalysts are sensitive to (and poisoned by) a variety of contaminants containing nitrogen, sulfur, halogens, and the like. Of these contaminants, sulfur is especially troublesome because the contamination is permanent—deactivating the catalyst for life.

One method of producing a syngas is via autothermal reforming. Autothermal reforming is a combination of partial oxidation and steam reforming of a natural gas stream wherein air is used as a source of oxygen for the partial oxidation reaction. Autothermal reforming generally includes the combination of a natural gas stream, an air stream, and a steam stream within a vessel containing a reforming catalyst (e.g., a nickel-containing catalyst) therein that converts the natural gas, air, and steam into a syngas.

When autothermal reforming is used, several potential sources of sulfur contaminants may be introduced into the system via the natural gas and air streams. Typically, the natural gas stream is pretreated to remove sulfur compounds to less than 10 parts per billion (ppb). Sulfur compounds in the air (e.g., sulfur dioxide, etc.) having concentrations above 10 ppb are not uncommon and are typically much higher in industrial areas. Thus, untreated air used during autothermal reforming has the potential of adding a variety of sulfur contaminants to the resultant syngas.

Additionally, untreated air has the potential of being a much larger source of sulfur poisons to the Fischer-Tropsch catalyst than the sulfur within natural gas streams because the volume of air used in autothermal reforming to produce a syngas is typically much greater (e.g., approximately three times) than the volume of natural gas. As such, it would be desirable to develop a method and process for pretreating the air stream to remove sulfur contaminants prior to utilizing the air for autothermal reforming to form the syngas.

### SUMMARY OF THE INVENTION

According to one embodiment of the present invention, a system for removing sulfur contaminants from an air stream prior to feeding the air stream to an autothermal reformer is disclosed. The air stream may be an oxygen-enriched air stream. The system comprises an air inlet, an air compressor, at least one furnace, a first desulfurization reactor, and the autothermal reformer. The air inlet is adapted to allow atmospheric air to enter therethrough to form the air stream. The air compressor is adapted to compress the air stream to a pressure greater than atmospheric pressure. The at least one furnace is adapted to heat the air stream to a temperature greater than atmospheric temperature. The first desulfurization reactor includes a first fixed bed. The first fixed bed comprises one or more metal oxides adapted to remove sulfur dioxide from the air stream to create a desulfurized air stream. The sulfur dioxide is removed from the air stream as the air stream moves through the first desulfurization reactor. The autothermal reformer is adapted to receive the desulfurized air stream and a desulfurized natural gas/steam stream and convert the received desulfurized air stream and the received desulfurized natural gas/steam stream into a synthesis gas stream substantially free of sulfur contaminants.

An oxygen-enriched air stream is enriched with oxygen by suitable techniques such as adsorption techniques, membrane technology, cryogenics, etc. An oxygen-enriched air stream generally includes about 20% to about 60% oxygen with the balance component being nitrogen. All references to the term “air” as used herein could include oxygen-enriched air.

According to another embodiment of the present invention, a method for inhibiting sulfur contaminants within a synthesis gas is disclosed. The method comprises the act of removing sulfur contaminants from a natural-gas stream by feeding the natural-gas stream into a gas desulfurization reactor. The gas desulfurization reactor is adapted to convert the sulfur contaminants into hydrogen sulfide. A resultant hydrogen-sulfide containing natural-gas stream is then fed into a hydrogen-sulfide removal system resulting in a desulfurized natural-gas stream. The method further comprises the act of removing sulfur dioxide from an air stream by feeding the air stream into a desulfurization reactor including a fixed bed. The air stream may be an oxygen-enriched air stream. The fixed bed comprises at least one metal oxide adapted to remove sulfur dioxide from the air stream to create a desulfurized air stream. The sulfur dioxide is removed from the air stream as the air stream moves through the desulfurization reactor resulting in a desulfurized air stream. The method further comprises the act of providing the desulfurized air stream and the desulfurized natural-gas stream along with steam to an autothermal reformer adapted to convert the desulfurized air stream, the desulfurized natural-gas stream, and the steam into a synthesis gas.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE DRAWINGS

FIG. 1 is a process schematic of a natural-gas pretreatment system for heating and decontaminating natural gas, according to one embodiment of the present invention.

FIG. 2 is a process schematic of an air desulfurization system for heating, compressing, and desulfurizing an air stream, according to one embodiment of the present invention.

FIG. 3 is a process schematic of a syngas production system for producing a syngas from the decontaminated natural-gas stream of FIG. 1 and the desulfurized air stream of FIG. 2, according to one embodiment of the present invention.

FIG. 4 is a process schematic of a contaminant removal system for the syngas stream of FIG. 3, according to one embodiment of the present invention.

FIG. 5 is a process schematic of a hydrocarbon conversion system for the controlled reaction of synthesis gas (carbon monoxide and hydrogen) to produce heavier hydrocarbons, according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

The present invention relates generally to the production of synthesis gas (syngas) from ambient air and a natural-gas stream followed by the synthesis of heavier hydrocarbons from the syngas. In particular, the present invention relates to a system and process for removing sulfur contaminants from a process air stream. The decontaminated process air stream is then fed into an autothermal reformer (ATR) to produce a synthesis gas containing at least carbon monoxide and hydrogen gas. The syngas is generated for use within a Fischer-Tropsch process to generate heavier hydrocarbons.

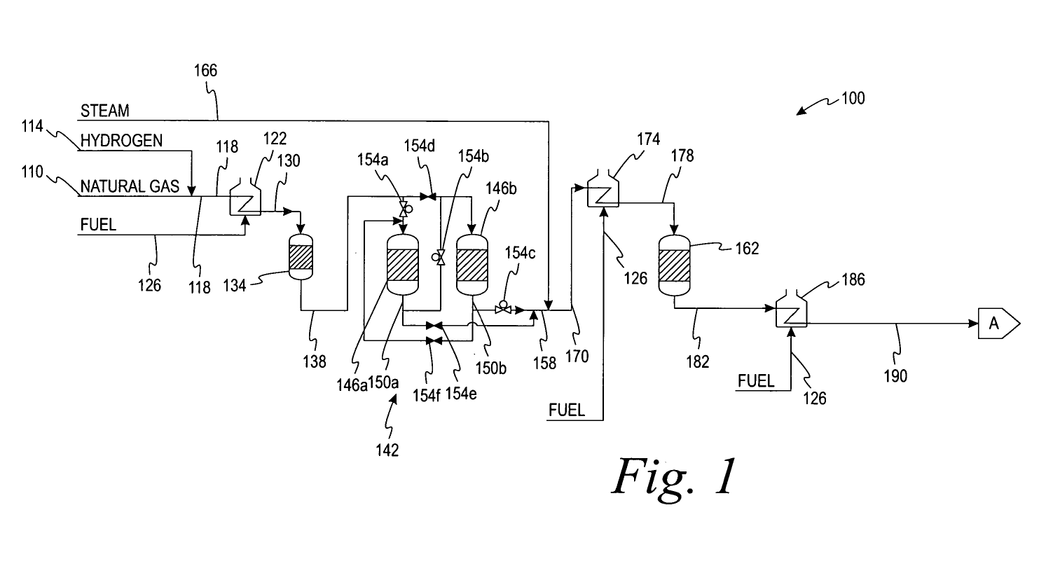

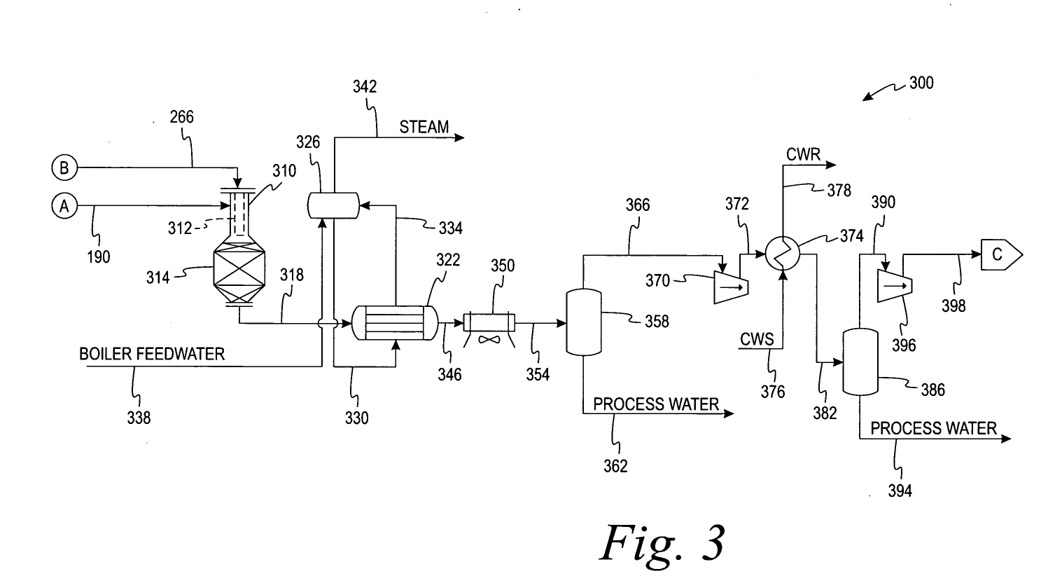

Referring now to FIG. 1, a natural-gas pretreatment system 100 for heating and decontaminating a natural-gas stream 110 is illustrated according to one embodiment. A typical natural-gas stream 110 contains sulfur and other contaminants that should be removed prior to feeding the natural gas to an ATR 310 (FIG. 3). A hydrogen-gas stream 114 is supplied to the natural-gas stream 110 and a resulting hydrogen-enriched, natural-gas stream 118 is heated in a furnace 122. The furnace 122 is fired by a fuel stream 126 supplied thereto. The fuel stream 126 may feed any suitable fuel to the furnace 122 sufficient to allow the furnace 122 to heat the hydrogen-enriched, natural-gas stream 118 to a desired temperature. Typically, the hydrogen-enriched natural-gas stream 118 is heated to a temperature range between about 500° F. (about 260° C.) and about 1000° F. (about 538° C.), and in some embodiments, to a temperature of about 750° F. (about 399° C.).

A resulting preheated, hydrogen-enriched, natural-gas stream 130 is then fed into a gas desulfurization reactor 134 to convert the sulfur compounds within the preheated, hydrogen-enriched, natural-gas stream 130 into hydrogen sulfide. The gas desulfurization reactor 134, in one embodiment, contains a catalyst bed that includes a cobalt-molybdenum catalyst on an alumina support. The cobalt-molybdenum catalyst, for example, reduces organic sulfur compounds to hydrogen sulfide and hydrolyzes both carbonyl sulfide and carbon sulfide into hydrogen sulfide. A resultant hydrogen-sulfide containing natural-gas stream 138 is then fed into a hydrogen-sulfide removal system 142.

The hydrogen-sulfide removal system 142 includes one or more adsorbent beds 146a-b containing material adapted to remove hydrogen sulfide from a natural-gas stream, such as zinc oxide. Where zinc oxide is utilized within the one or more adsorbent beds 146a-b, the reaction between the hydrogen sulfide in the hydrogen-sulfide containing natural gas stream 138 and the zinc oxide in the adsorbent beds 146a-b results in the formation of a zinc sulfide and water vapor. The zinc sulfide is retained in the adsorbent beds 146a-b and one or more desulfurized natural-gas streams 150a-b exit the reactors without the sulfur contaminants.

As illustrated in FIG. 1, two adsorbent beds 146a-b are positioned in series and allow for the substantially continuous removal of hydrogen sulfide from the hydrogen-sulfide containing stream 138. A plurality of valves 154a-f are utilized to control the flow of the hydrogen-sulfide containing stream 138 between the adsorbent beds 146a-b. By positioning a plurality of adsorbent beds 146a-b in series, a first adsorbent bed (e.g., 146a) can be used to remove the hydrogen sulfide from the hydrogen-sulfide containing stream 138 prior to the desulfurized gas stream (e.g., 150a) being fed to the second adsorbent bed (e.g., 146b). This process arrangement is referred to as a lead-lag arrangement. Once the zinc oxide within the first adsorbent bed 146a is substantially converted to zinc sulfide, thus becoming ineffective at removing the hydrogen sulfide, the hydrogen-sulfide containing stream 138 is redirected by the plurality of valves 154a-f to first enter the second adsorbent bed 146b. This allows the first adsorbent bed 146a to be dumped and recharged with fresh zinc oxide while the second adsorbent bed 146b removes the hydrogen sulfide from the hydrogen-sulfide containing stream 138. After bed 146a is recharged, it is put back in service downstream of 146b. The adsorbent beds 146a-b can be alternated as the lead reactor so that a fresh zinc oxide bed is always in service for removal of the hydrogen sulfide.

A resulting desulfurized gas stream 158 exits the hydrogen-sulfide removal system 142. Following the removal of the sulfur from the natural gas stream 110, it may be necessary to convert the heavier hydrocarbons in the natural gas (e.g., ethane and heavier) to methane. Methane is less likely, by far, to produce carbon in the ATR 310 (FIG. 3). The conversion of the heavier hydrocarbons into methane (de-enrichment) may be facilitated, for example, by a pre-reformer 162. Prior to entering the pre-reformer 162, however, steam is added to the desulfurized gas stream 158 via a steam stream 166. The steam stream 166 may be provided, for example, from a boiler or other steam generation unit within or apart from the system for converting lighter hydrocarbons into heavier hydrocarbons. The desulfurized-gas/steam stream 170 is fed to a furnace 174 for heating the desulfurized-gas/steam stream 170 to the desired temperature prior to feeding the resultant heated, desulfurized-gas/steam stream 178 to the pre-reformer 162. According to one embodiment, the furnace 174 heats the desulfurized-gas/steam stream 170 to a temperature range between about 500° F. (about 260° C.) and about 1000° F. (about 538° C.), and in some embodiments, to a temperature of about 750° F. (about 399° C.).

The heated desulfurized-gas/steam stream 178 is fed to the pre-reformer 162 where the heated desulfurized-gas/steam stream 178 flows through a fixed catalyst bed that converts the heavier hydrocarbons to methane. This process may also produce detectable quantities of carbon monoxide, carbon dioxide, and hydrogen gas. Pre-reforming catalysts are commercially available and are manufactured by Johnson Matthey in London, England, Haldor Topsoe in Houston, Tex., and Süd Chemie in Munich, Germany.

A de-enriched gas/steam stream 182 exits the pre-reformer 162 and is then heated by a furnace 186 if necessary. The furnace 186 is fired by the fuel stream 126 supplied thereto. The fuel stream 126 may feed any suitable fuel to the furnace 186 sufficient to allow the furnace 186 to heat the de-enriched gas/steam stream 182 to a desired temperature. According to one embodiment, the de-enriched gas/steam stream 182 is heated to a temperature range between about 500° F. (about 260° C.) and about 1200° F. (about 649° C.), and in some embodiments, to a temperature range of about 800° F. (about 426° C.) and about 850° F. (about 455° C.). A resultant heated, de-enriched gas/steam stream 190 is then fed to the ATR 310 as will be further described with respect to FIG. 3.

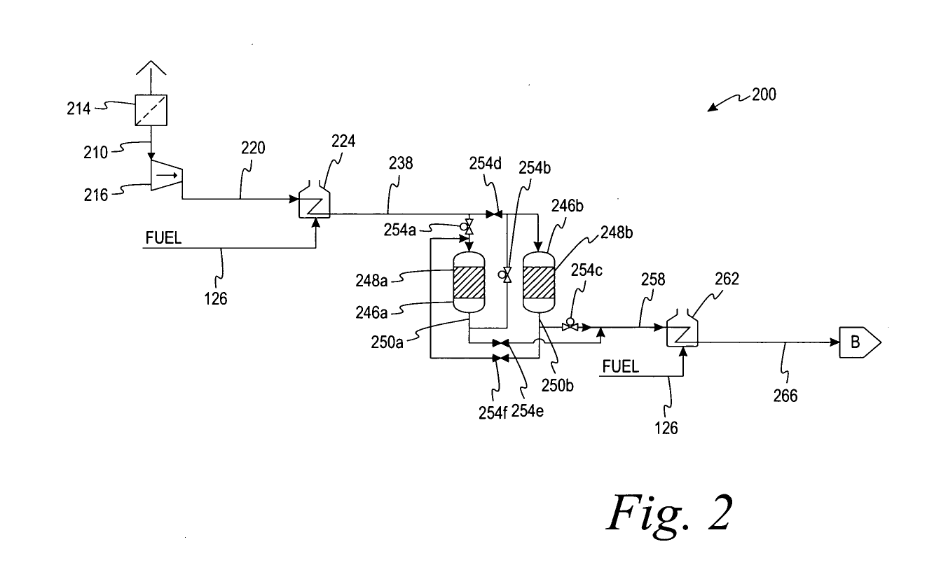

Turning now to FIG. 2, an air desulfurization system 200 is illustrated, according to one embodiment of the present invention. The air desulfurization system 200 is utilized to remove a majority of the sulfur contaminants from the air that will be supplied to the ATR 310 (FIG. 3) to produce a syngas. The removal of sulfur contaminants from the air is important because of the potential for adding a variety of sulfur contaminants to a resultant syngas if an untreated air stream is provided directly to the ATR 310. It is desirable to remove the sulfur contaminants from both the natural-gas stream 110 and an air stream 210 prior to feeding the streams to the ATR 310 because it is easier and more cost efficient to remove the sulfur contaminants from these streams than from a resultant syngas stream.

It is also contemplated that the air desulfurization system 200 described herein may use an oxygen-enriched air stream. An oxygen-enriched air stream is enriched with oxygen using suitable techniques such as adsorption techniques, membrane technology, or cryogenics. An oxygen-enriched air stream generally includes about 20% to about 60% oxygen with the balance component being nitrogen.

In the air desulfurization system 200, the intake for the air stream 210 is through an air inlet 214. The air inlet 214 allows atmospheric air to enter the air desulfurization system 200 where it can be processed and then provided to the ATR 310 (FIG. 3) to produce a syngas. The air inlet 214, in some embodiments, includes filtration or separation equipment to prevent rain, liquids, debris, particulates, or other undesirables from entering the air inlet 214. The air stream 210 is fed to an air compressor 216 that compresses the air stream 210 to a pressure from about 150 psig to about 400 psig while, in some embodiments, the air stream 210 is compressed from about 150 psig to about 200 psig. From the air compressor 216, a resultant compressed air stream 220 is conducted to a furnace 224. The furnace 224 is fired by the fuel stream 126 supplied thereto. The fuel stream 126 may feed any suitable fuel to the furnace 224 sufficient to allow the furnace 224 to heat the compressed air stream 220 to the desired temperature. Typically, the furnace 224 heats the compressed air stream 220 to a temperature in the range of from about ambient temperature to about 1000° F. (about 538° C.). In some embodiments, the furnace 224 heats the compressed air stream 220 to a temperature in the range of from about 750° F. (about 398° C.) to about 850° F. (about 455° C.). In some of these embodiments, the furnace 224 heats the compressed air stream 220 to a temperature of approximately 800° F. (about 426° C.). In alternative embodiments, other types of heaters can replace the furnace 224. For example, a heat exchanger, a furnace coil heater, or another type of radiant or convection heater (not shown) may be used to heat the compressed air stream 220.

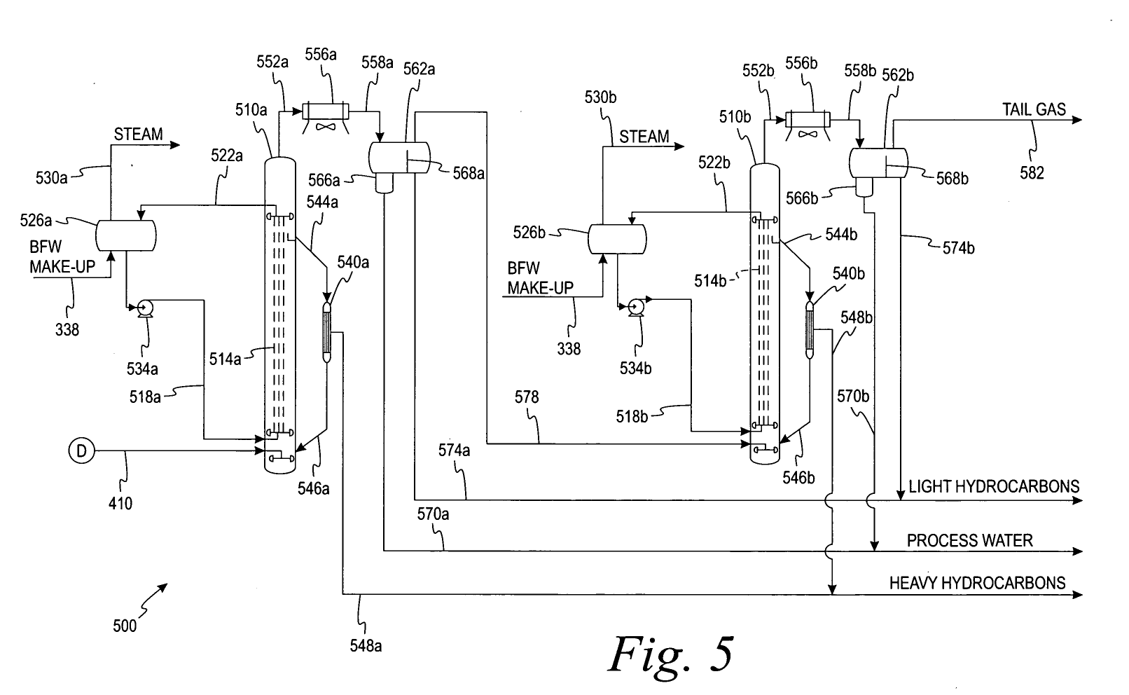

A resultant heated air stream 238 exits the furnace 224 and is fed to a first desulfurization reactor 246a in the illustrated embodiment. The heated air stream 238 generally includes detectable quantities of sulfur dioxide, the major sulfur contributor from the atmosphere. This potential sulfur contaminant should be removed from the heated air stream 238 prior to being fed to the ATR 310 (FIG. 3). As discussed below in connection with FIG. 3, by removing the sulfur dioxide prior to forming the syngas, the potential for contamination of the syngas stream utilized in a Fischer-Tropsch process is reduced. The removal of the sulfur contaminants from the syngas stream helps to increase the life of the catalyst and productivity of a hydrocarbon conversion system 500 (FIG. 5).

According to one embodiment, the first desulfurization reactor 246a has a fixed bed 248a therein that includes one or more metal oxides such as, for example, copper oxide. It is believed that the fixed bed 248a of copper oxide removes the sulfur dioxide from the heated air stream 238 by reacting with the sulfur oxide to form a copper sulfate in a solid form, according to the following reaction scheme:
CuO+SO₂+½O₂→CuSO₄
This reaction scheme highly favors the formation of copper sulfate at equilibrium, even where gaseous oxygen is at low levels. Thus, where oxygen levels are relatively high (e.g., <20% by volume), the formation of copper sulfate is even further favored. According to one embodiment, the oxygen level within the heated air stream 238 is approximately 21% by volume and, as such, favors the formation of the copper sulfate solid.

The fixed bed 248a of copper oxide can be selected from any appropriate commercially available catalyst or may be manufactured specifically for use in a particular air desulfurization system. For example, the copper oxide catalyst may be a commercially available, low temperature, shift conversion catalyst. These catalysts have a composition that typically has both copper oxide and zinc oxide on an alumina (Al₂O₃) support. The copper oxide is very finely dispersed resulting in a large, stable copper surface area and an inherently high activity. Manufacturers of this type of catalyst include Johnson Matthey in London, England, Haldor Topsoe in Houston, Tex., Süd Chemie in Munich, Germany, and Engelhard (now BASF) in Germany. These catalysts are typically manufactured to promote the water shift reaction of carbon monoxide to carbon dioxide and hydrogen gas (CO+H₂O [symbol] CO₂+H₂). In this application, the catalyst operates in a reducing environment as a true catalyst. When used in an oxidizing environment in the presence of sulfur dioxide, the copper oxide acts as a chemical adsorbent and reacts with the sulfur dioxide and oxygen gas to produce copper sulfate. The copper sulfate formed, remains a solid on the catalyst, thus effectively removing the sulfur from the air stream being treated.

The copper oxide is consumed over time and the ability of the fixed bed 248a to remove sulfur dioxide from the air stream is a function of the quantity of catalyst in the fixed bed 248a similar to the zinc oxide used for the removal of hydrogen sulfide. However, unlike zinc sulfide, copper sulfate can be regenerated according to the following reaction:
CuSO₄+4H₂ [symbol] CuO+3H₂O+H₂S
An economic evaluation is recommended to determine if it is cost effective to regenerate the copper oxide or if the bed should be dumped and recharged when it is spent. Regardless, with either option, a two bed system in a lead-lag configuration may be used such that one bed is always in service to remove the sulfur dioxide while the spent bed is being recharged or regenerated.

The fixed bed 248a is of sufficient size to desulfurize approximately at least 8,000 gas hourly space velocities (GHSV). In some embodiments, the fixed bed 248a may be of sufficient size to remove a substantial amount of the sulfur dioxide from the heated air stream 238 from at least approximately 20,000 GHSV. Thus, as the amount of heated air being required by and, thus, fed into the ATR 310 (as described below in connection with FIG. 3) increases, so does the size and capacity of the fixed bed 248a containing the copper oxide catalyst.

An example of a lead-lag arrangement of fixed beds 248a-b is illustrated in FIG. 2, according to one embodiment. The heated air stream 238 is fed into a top portion of the first desulfurization reactor 246a. The heated air stream 238 moves through the fixed bed 248a of the copper oxide catalyst towards an outlet (not shown) located on a lower portion of the first desulfurization reactor 246a. As the heated air stream 238 moves through the fixed bed 248a, the sulfur dioxide forms copper sulfate and plates out of the heated air stream 238 and remains in the fixed bed 248a. A first desulfurized air stream 250a exits the first desulfurization reactor 246a via the outlet and is fed, in some embodiments, to a second desulfurization reactor 246b containing the fixed bed 248b of desulfurization catalyst such as a metal oxide.

As illustrated, the first desulfurization reactor 246a and the second desulfurization reactor 246b are positioned in series and allow for the substantially continuous desulfurization of the heated air stream 238. A plurality of valves 254a-f are positioned so as to direct the heated air stream 238 to either the first desulfurization reactor 246a or the second desulfurization reactor 246b. The plurality of valves 254a-f then direct the exiting desulfurized air stream to either the second desulfurization reactor 246b or the first desulfurization reactor 246a, respectively.

As illustrated in FIG. 2, the heated air stream 238 is fed first to the first desulfurization reactor 246a through the open valve 254a. The first desulfurized air stream 250a exits the first desulfurization reactor 246a and travels through the open valve 254b before being fed to the second desulfurization reactor 246b. The first desulfurized air stream 250a proceeds through the second desulfurization reactor 246b and a second desulfurized air stream 250b exits the second desulfurization reactor 246b. The second desulfurized air stream 250b then travels through valve 254c and forms a desulfurized air stream 258.

A detection mechanism (not shown) is provided to determine the concentration of sulfur within the first desulfurized air stream 250a. Typical detection mechanisms are capable of detecting sulfur dioxide levels in excess of 10 ppb. Standard detection mechanisms such as a sulfur speciated gas chromatograph available from Antek Instruments in Houston, Tex. can be utilized by the present invention.

The detection mechanism monitors the sulfur dioxide levels within the first desulfurized air stream 250a exiting the first desulfurization reactor 246a. If the sulfur dioxide level within the first desulfurized air stream 250a is below a detectable level or, in alternative embodiments, a predetermined threshold level, the first desulfurized air stream 250a proceeds to the second desulfurization reactor 246b. The desulfurized air stream 250a proceeds through the fixed bed 248b and exits the second desulfurization reactor 246b forming a second desulfurized air stream 250b. The second desulfurization reactor 246b potentially, though not necessarily, removes additional amounts of sulfur dioxide from the first desulfurized air stream 250a as the first desulfurized air stream 250a moves through the second desulfurization reactor 246b.

Alternatively, if the sulfur dioxide level within the first desulfurized air stream 250a is above the detectable or, in alternative embodiments, the predetermined threshold level, the detection mechanism sends a notification to the control circuitry (not shown) that the fixed bed 248a of metal oxide is no longer desulfurizing the heated air stream 238 at acceptable levels. The control circuitry or operator closes the valve 254a temporarily and the remaining heated air stream 238 in the first desulfurization reactor 246a is allowed to exit the first desulfurization reactor 246a. The first desulfurized air stream 250a proceeds to the second desulfurization reactor 246b where additional amounts of sulfur dioxide are purged from the first desulfurized air stream 250a.

In some embodiments, once the remaining first desulfurized air stream 250a has exited the second desulfurization reactor 246b, the valve 254d is opened so as to feed the heated air stream 238 directly into the second desulfurization reactor 246b. At the same time, the valves 254b and 254c are closed, whereas valves 254e and 254f are opened. Thus, when the heated air stream 238 is being fed directly to the second desulfurization reactor 246b, the valves 254d, 254e, and 254f are open while the valves 254a, 254b, and 254c are closed.

In alternative embodiments, however, the valve 254d is opened and the valve 254a is closed as soon as the detection mechanism detects a level of sulfur dioxide above detectable or threshold levels.

Once the valve 254d has been opened, the heated air stream 238 is directly fed to the second desulfurization reactor 246b through the valve 254d. The metal oxide provided on the fixed bed 248b removes at least a portion of the sulfur dioxide from the heated air stream 238. The second desulfurized air stream 250b exits the second desulfurization reactor 246b and travels through the valve 254f before being fed to the first desulfurization reactor 246a. The second desulfurized air stream 250b then exits the first desulfurization reactor 246a and travels through the valve 254e and forms the desulfurized air stream 258.

A detection mechanism (not shown) monitors the sulfur dioxide levels within the second desulfurized air stream 250b exiting the second desulfurization reactor 246b. The heated air stream 238 continues to be fed directly to the second desulfurization reactor 246b until the detection mechanism detects sulfur dioxide levels that are in excess of acceptable levels. The detection mechanism then sends a notification to the control circuitry and the heated air stream 238 is redirected to the first desulfurization reactor 246a prior to being fed to the second desulfurization reactor 246b.

The above-described desulfurization scheme provides the ability to continuously desulfurize an air stream to prevent unacceptable levels of sulfur dioxide from reaching the ATR 310 (as described below in connection with FIG. 3) and potentially reaching the Fischer-Tropsch catalyst.

In alternative embodiments, however, a single desulfurization reactor may be utilized. In these embodiments, the heated air stream 238 is not fed into the desulfurization reactor once the metal oxide or catalyst has become ineffective at removing the detectable or threshold quantities of sulfur dioxide. The heated air stream is only fed to the desulfurization reactor after the ineffective metal oxide or catalyst has been replaced or regenerated.

The desulfurized air stream 258 is fed to a furnace 262 fired by the fuel stream 126 that is supplied thereto. The fuel stream 126 may feed any suitable fuel to the furnace 262 sufficient to allow the furnace 262 to heat the desulfurized air stream 258 to a desired temperature. Typically, the furnace 262 heats the compressed air stream to a temperature in the range of from about 500° F. (about 260° C.) to about 1000° F. (about 538° C.). In some embodiments, the furnace 262 heats the desulfurized air stream 258 to a temperature in the range of from about 800° F. (about 426° C.) to about 850° F. (about 455° C.). In alternative embodiments, other types of heaters can replace the furnace 262. For example, a heat exchanger, a furnace coil heater, or another type of radiant or convection heater may be used to heat the desulfurized air stream 258. A resultant heated, desulfurized air stream 266 exits the furnace 262 and is fed to the ATR 310 (FIG. 3) as will be described below.

Referring also to FIG. 3, a system and method for producing a syngas is illustrated, according to one embodiment. Within the syngas production system 300, the heated, de-enriched gas/steam stream 190 (from the natural gas pretreatment system of FIG. 1) and the heated, desulfurized air stream 266 (from the air desulfurization system of FIG. 2) are fed to a syngas generator, such as the ATR 310. Both the heated, de-enriched gas/steam stream 190 and the heated, desulfurized air stream 266 have previously been desulfurized (FIGS. 1-2) prior to being fed to the ATR 310. The ATR 310 includes a gas and air mixer 312 connected to one end of the ATR 310. A bed of steam reforming catalyst 314, which typically contains nickel, is disposed within the ATR 310 at the end opposite the gas and air mixer 312. The bed of steam reforming catalyst 314 can be any of the noble or non-noble metal supported steam reforming catalysts readily available from numerous suppliers. Nickel on alumina is an example of such a catalyst. Suitable catalysts are well known in the art and are available from several sources, including Johnson Matthey in London, England, Haldor Topsoe in Houston, Tex., Süd Chemie in Munich, Germany, or Engelhard (now BASF) in Germany.

The bed of steam reforming catalyst 314 is covered by a layer of inert support material. The inert support layer prevents the back-radiation of heat from the support zone into the incoming heated, de-enriched gas/steam stream 190. The quantity of catalyst within the bed of steam reforming catalyst 314 corresponds to a gas hourly space velocity (GHSV) of about 5,000 to about 40,000 based on standard cubic feet per hour or the total feed gas. In some embodiments, the quantity of catalyst corresponds to a GHSV of about 8,000 to about 20,000 based on the total feed flow. The quantity of the inert support material is at least the minimum required to prevent excessive radiant heat transfer into the bulk stream. That is, the inert support material is loaded to a depth in which the top layer of the support remains at the same temperature as the incoming heated, de-enriched gas/steam stream 190 (e.g., about 800° F. (about 426° C.) to about 850° F. (about 455° C.)). For example, the quantity of the inert support material may be an amount sufficient to cover the bed of steam reforming catalyst 314 to a depth of about six inches (about 15 centimeters) to about twelve inches (about 30 centimeters).

The ATR 310 may be a refractory-lined carbon steel vessel. Optionally, steam, carbon dioxide, or both may be introduced into the ATR 310 to assist in the formation of carbon monoxide and hydrogen gas within the ATR 310. The ATR 310 may be operated with a pressure between about 50 psig and about 500 psig. Typically, the ATR 310 is operated between about 100 psig and about 150 psig.

In the operation of the ATR 310, the heated, de-enriched gas/steam stream 190 is intimately mixed with the heated, desulfurized air stream 266 in the gas and air mixer 312 above the inert support material. The near homogeneous air/gas/steam mixture passes from the gas and air mixer 312 through the inert support material and into the steam reforming catalyst bed 314, whereby the combustion reaction takes place within the ATR 310. The combustion reaction is carried out at a temperature in the range of from about 1500° F. (815° C.) to about 2500° F. (1372° C.) under sub-stoichiometric conditions whereby the light hydrocarbons within the ATR 310 are partially oxidized. A resultant syngas stream 318 including nitrogen, unreacted light hydrocarbons, hydrogen gas, and carbon monoxide is produced by the ATR 310.

Due to the heat of reaction within the ATR 310, the syngas stream 318 exits the ATR 310 at a temperature of between about 1500° F. (815° C.) to about 2500° F. (1372° C.) and typically, at about 1800° F. (982° C.). The syngas stream 318 is cooled rapidly within a quench boiler 322 such that the syngas stream 318 has little residence time exposed to metal materials (e.g., to avoid “metal dusting”). The quench boiler 322 typically cools the syngas stream 318 to a temperature range of between about 400° F. (204° C.) to about 650° F. (344° C.) and in some embodiments, to about 550° F. (288° C.).

The syngas stream 318 is cooled within the quench boiler 322 by passing the syngas stream 318 through tubes carrying steam. The tubes are arranged in a bundle contained in a process quench boiler vessel. Boiler feed water (BFW) is supplied from a steam drum 326 via a BFW feed line 330. The tube bundle is completely submerged in boiler feedwater supplied by the BFW feed line 330. The BFW temperature is near its bubble point and enters the bottom of the quench boiler 322 and flows upward through the tube bundle. Heat from the syngas stream 318 is transferred to the BFW, thus, cooling the syngas stream 318 and heating the BFW. Because the BFW entered the quench boiler 322 near its bubble point, the heat transferred to the BFW causes a portion of the BFW to vaporize (boil). The two-phase BFW and water vapor (steam) stream flow through the tube bundle and out of the quench boiler 322 into an outlet line 334 and back to the steam drum 326 where the water vapor (steam) is separated from the BFW. The produced steam leaves the steam drum 326 via a steam exhaust 342 and may be used by the overall process as a heat source. The steam drum 326 is supplied with additional water to create steam by a make-up BFW stream 338.

A cooled, syngas stream 346 exits the quench boiler 322 and is further cooled by an air-cooled heat exchanger 350, followed by a cooling water exchanger (optional). The cooled syngas stream 346 is cooled by the air-cooled heat exchanger 350, in the illustrated embodiment, to a temperature in the range of about 100° F. (37° C.) to about 150° F. (66° C.). A resultant further-cooled, syngas stream 354 is then fed into a first accumulator 358. The first accumulator 358 allows process water that has condensed due to the cooling of the syngas stream 318 to be removed via a process-water outlet 362. The removed process water may be reused by the overall process as desired. Depending on where the removed process water is to be reused by the system, the removed process water may undergo further treatment or decontamination prior to being reused.

A resultant separated syngas stream 366 exits the top of the first accumulator 358 and is compressed by a compressor 370. The compressor 370, in the illustrated embodiment, may compress the separated syngas stream 366 to a pressure of about 150 psig to about 450 psig, and in some embodiments, to a range between about 260 psig and about 420 psig. The syngas compression may require a multiple-stage compressor, as shown, to reach the desired Fischer-Tropsch reactor pressure. For a two-stage syngas compressor as shown, a resultant partially-compressed syngas stream 372 is cooled by a cooling-water heat exchanger 374. The cooling-water heat exchanger 374 transfers heat from the partially-compressed syngas stream 372 to a cooling water supply 376 supplied to the cooling-water heat exchanger 374. The temperature of the cooling water supply 376 increases and the cooling water supply 376 exits the cooling-water heat exchanger 374 via the cooling water return 378. Alternatively or additionally, an air-cooled heat exchanger could be used to cool the partially-compressed syngas stream 372. Where the cooling-water heat exchanger 374 is used, the partially-compressed syngas stream 372 is cooled to a temperature between about 80° F. (26° C.) and about 150° F. (66° C.), and typically to about 100° F. (37° C.). Alternatively, where an air-cooled heat exchanger is used, the partially-compressed syngas stream 372 is cooled to a temperature between about 100° F. (37° C.) and about 150° F. (66° C.), and typically to about 120° F. (48° C.) to about 130° F. (55° C.).

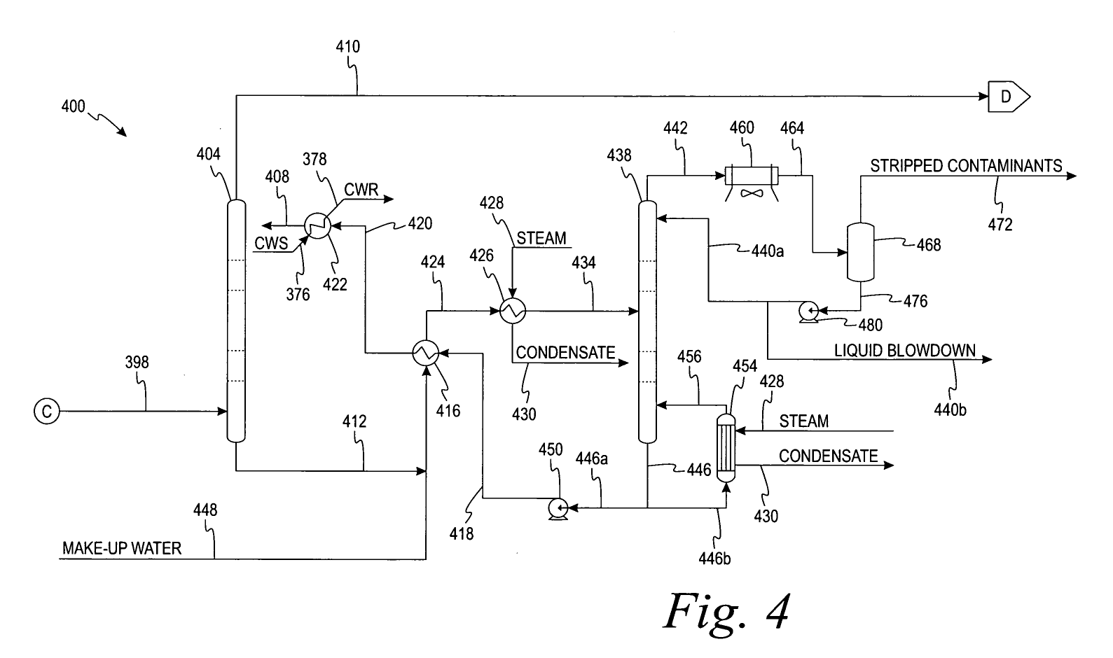

A resultant cool, partially-compressed syngas stream 382 exits the cooling-water hear exchanger 374 and is fed to a second accumulator 386. The second accumulator 386 facilitates the separation of the syngas from the process water that has condensed because of the cooling by the cooling-water heat exchanger 374. A resultant further-separated syngas stream 390 exits from a top portion of the second accumulator 386, while the separated process water exits from a bottom portion of the second accumulator 386 via a process-water outlet 394. The further-separated syngas stream 390 is then fed to a second-stage compressor 396 located downstream from the first compressor 370. The second-stage compressor 396 further compresses the further-separated syngas stream 390 to a pressure between about 350 psig to about 600 psig, and in some embodiments, to a pressure between about 400 psig and about 450 psig. A resultant high-pressure syngas stream 398 exits the second-stage compressor 396 and is then processed through a contaminant-removal system 400, as illustrated in FIG. 4.

Turning now to FIG. 4, the contaminant-removal system 400 is adapted to decontaminate the high-pressure syngas stream 398—produced by the syngas production system 300 of FIG. 3—according to one embodiment. According to some embodiments, the contaminant-removal system 400 utilizes a water-wash process for decontaminating the high-pressure syngas stream 398, as illustrated in FIG. 4. The conditions within the syngas production system 300 generally, and specifically the ATR 310, typically produce other contaminants such as reactive nitrogen compounds (e.g., ammonia and hydrogen cyanide) within the high-pressure syngas stream 398. While these nitrogen contaminants are not permanent poisons to Fischer-Tropsch catalysts, they do cause a loss in activity of the Fischer-Tropsch catalysts and it is desirable to remove these nitrogen contaminants from the high-pressure syngas stream 398. The contaminant-removal system 400 provides a decontamination process capable of removing a majority of the reactive nitrogen compounds from the high-pressure syngas stream 398. Though a water-wash process is illustrated with respect to FIG. 4, other fluid washing systems, or combinations of fluids with water can be utilized to wash and decontaminate the high-pressure syngas stream 398. For example, refrigerated or non-refrigerated glycols or alcohols may alternatively or additionally be used.

To remove these potential nitrogen contaminants, the high-pressure syngas stream 398 is first fed to a water-wash absorber 404. The water-wash absorber 404 may be a trayed or a packed-column absorber. Within the water-wash absorber 404, the high-pressure syngas stream 398 countercurrently contacts a water stream 408 fed into an upper portion of the water-wash absorber 404. The water stream 408 is fed into the water-wash absorber 404 above the feed of the high-pressure syngas stream 398. The high-pressure syngas stream 398 is fed into a lower portion of the water-wash absorber 404, thus, producing the countercurrent gas and liquid flows within the water-wash absorber 404. The high-pressure syngas stream 398 proceeds upward through the water-wash absorber 404 and contacts the water stream 408. A resultant water-washed syngas stream 410 exits the top of the water-wash absorber 404. The water-washed syngas stream 410 typically exits the water-wash absorber 404 with a temperature in the range of about 40° F. (4° C.) to about 160° F. (72° C.), and in some embodiments, between about 100° F. (37° C.) and about 120° F. (49° C.). The water-washed syngas stream 410 is then further processed through a hydrocarbon conversion system 500 as will be detailed below with respect to FIG. 5.

Similarly, the water stream 408 proceeds downward in the water-wash absorber 404 and contacts the high-pressure syngas stream 398. The contact between the water stream 408 and the high-pressure syngas stream 398 allows some of the nitrogen contaminants to be absorbed by the water stream 408 from the high-pressure syngas stream 398. A level control valve (not shown) is located in the outlet line from the water-wash absorber 404. The level control valve allows a portion of a resulting wash-water stream 412—which includes a majority of the nitrogen contaminants originally within the high-pressure syngas stream 398—to exit the water-wash absorber 404 to be further processed.

The water stream 408 is fed into the water-wash absorber 404 at a temperature in the range of about 40° F. (4° C.) to about 150° F. (66° C.), and in some embodiments, at about 100° F. (37° C.) to about 120° F. (49° C.). Generally, the temperature of the water stream 408 is kept as low as is economically feasible to facilitate the absorption of nitrogen contaminants by the water stream 408. A small amount of heat may be generated within the water-wash absorber 404 due to the physical absorption of the nitrogen contaminants. Thus, the resulting wash-water stream 412 generally has a temperature in the range of about 40° F. (4° C.) to about 180° F. (83° C.), and in some embodiments, between about 120° F. (48° C.) and about 150° F. (66° C.).

After exiting the water-wash absorber 404, the wash-water stream 412 is fed to a heat exchanger 416. A make-up water stream 448 is mixed with the wash-water stream 412 before it enters the heat exchanger 416. The heat exchanger 416 is also fed by a recirculated water stream 418 having a temperature of about 200° F. (93° C.) to about 300° F. (149° C.), and in some embodiments, between about 240° F. (115° C.) and about 250° F. (122° C.). The heat exchanger 416 allows the recirculated water stream 418 and the wash-water stream 412 to exchange heat thus, increasing the temperature of the wash-water stream 412 and decreasing the temperature of the recirculated water stream 418. A resulting cooled, recirculated water stream 420 exits the heat exchanger 416 and is then fed into a cooling-water heat exchanger 422.

The cooling-water heat exchanger 422 transfers heat from the cooled, recirculated water stream 420 to the incoming cooling-water supply 376 supplied to the cooling-water heat exchanger 422. The temperature of the cooling water supply 376 increases and exits the cooling-water heat exchanger 422 via the cooling water return 378. The cooled, recirculated water stream 420 is further cooled by the cooling-water heat exchanger 422 to a temperature between about 80° F. (26° C.) and about 150° F. (66° C.), and typically to about 100° F. (37° C.) to about 120° F. (49° C.). A flow control valve (not shown) controls the wash-water flow to the water-wash absorber 404 to ensure that a sufficient quantity of wash water is delivered to the water-wash absorber 404 to absorb a desired amount of the nitrogen contaminants. The resultant water stream 408 may be additionally cooled by alternative or additional means if it is desirable or economically feasible to utilize cooler water. The water stream 408 is then fed into the water-wash absorber 404 as described above.

Similarly, a warm wash-water stream 424 results from the exchange of heat within the heat exchanger 416. The warm wash-water stream 424 is then fed to a stripper pre-heater 426 such as a steam-stream heat exchanger. The steam-stream heat exchanger, for example, transfers heat from a steam stream 428 to the warm wash-water stream 424 resulting in a condensate stream 430 exiting the heat exchanger. The stripper pre-heater 426 also results in a heated, wash-water stream 434 having a temperature in the range of about 190° F. (87° C.) to about 300° F. (149° C.), and in some embodiments, between about 200° F. (93° C.) and about 220° F. (105° C.). The resultant heated, wash-water stream 434 exits the stripper pre-heater 426 and is fed into a wash-water stripper 438.

The wash-water stripper 438 serves as a means to separate the nitrogen contaminants from the water stream by stripping the absorbed nitrogen contaminants from the heated, wash-water stream 434. The wash-water stripper 438 operates at a much lower pressure than the water-wash absorber 404. For example, the wash-water stripper 438 generally has an operating pressure between about 0 and about 50 psig and in some instances between about 3 to about 7 psig. The nitrogen contaminants absorbed by the cool, wash water at high pressure (e.g., 450 psig) in the water-wash absorber 404 are easily stripped from the heated, wash-water stream 434 at a low pressure (e.g., 5 psig) in the wash-water stripper 438.

The wash-water stripper 438 may be a trayed or a packed column having equilibrium stages that separate the nitrogen contaminants from the heated, wash-water stream 434. The heated, wash-water stream 434 enters the wash-water stripper 438 near the center of the trays or packed areas within the column. The number of actual trays or the height of packing equivalent to an equilibrium stage varies with the vapor and liquid loadings and the specific tray or packing selected. The desired purity of the stripped water leaving the wash-water stripper 438 may be used to determine the number of equilibrium stages desired within the wash-water stripper 438.

Any vapor (steam, vaporized nitrogen contaminants, etc.) in the heated, water-wash stream 434 flows upward through the wash-water stripper 438. The vapor from the entering heated, wash-water stream 434 combines with steam and nitrogen contaminant vapor generated by a stripper reboiler 454 and is stripped from the wash-water in the lower portion of the wash-water stripper 438. As the vapor rises through the upper portion of the wash-water stripper 438, it contacts a cooled water stream, stripper reflux 440a generated by a stripper overhead condenser 460 and is returned to the column via a stripper overhead accumulator 468 and a stripper reflux pump 480 through the stripper reflux 440a line. As the vapors flow upward and contact the cooled reflux, a portion of the steam in the rising vapor condenses and joins the reflux flowing down the wash-water stripper 438, while the nitrogen contaminants in the vapor and any recycled contaminants continue to rise until they exit the column as a stripper overhead stream 442.

The stripper overhead stream 442 enters the stripper overhead condenser 460. The stripper overhead condenser 460 may be an air cooler, a water cooler, or a combination of the two. The stripper overhead condenser 460 cools and condenses the majority of the water vapor in the stripper overhead stream 442. This cooled and partially condensed water stream and the nitrogen contaminants flow to the overhead accumulator 468 as a cooled, stripper overhead stream 464. The overhead accumulator 468 facilitates the separation of the vapor and the liquid within the cooled, stripper overhead stream 464. The vapor generally contains water vapor and stripped nitrogen contaminants. Typically, the liquid is primarily water with some absorbed nitrogen contaminants.

The vapor forms a stripped-contaminants stream 472 that exits from a top portion of the stripper-overhead accumulator 468. The liquid flows from the overhead accumulator 468 as a condensate stream 476 to the stripper reflux pump 480. The stripper reflux pump 480 pumps a portion of the condensate stream 476 back to the top of the wash-water stripper 438 through a stripper reflux line as stripper reflux 440a. A small portion of the liquid becomes a liquid blowdown and exits the system through blowdown line 440b. Liquid blowdown is taken from the stripper overhead because it contains the highest concentration of absorbed nitrogen contaminants, and thus, the blowdown reduces the nitrogen contaminant level in the recycled wash-water.

The liquid portion of the heated, wash-water stream 434 flows downward from the wash-water inlet. The liquid wash-water contacts a vapor stream generated by the stripper reboiler 454 as the heated, wash-water stream 434 flows downward within the wash-water stripper 438. The hot vapor strips the nitrogen contaminants from the wash water. As the wash water progresses down the wash-water stripper 438, it contains less nitrogen contaminants. When it reaches the bottom of the wash-water stripper 438, it has been stripped of most of the nitrogen contaminants and is ready to be recycled as wash water. The wash water exits the wash-water stripper 438 as a wash-water stream 446. The wash-water stream 446 splits and a portion 446a of the wash-water stream 446 is recycled to the water-wash absorber 404 via a stripper-bottoms pump 450. The remaining portion 446b of the wash-water stream 446 is delivered to the reboiler 454 where it is partially vaporized to generate the stripping steam and returned to the wash-water stripper 438 via a reboiler output stream 456.

According to one embodiment, the reboiler 454, which generates the stripping steam, is a heat exchanger with wash-water on one side and steam on the other. A steam stream 428 enters the reboiler 454 and is condensed as it exchanges heat with the remaining portion 446b of the wash-water stream 446 through a heat transfer surface, typically comprising a plurality of tubes. The latent heat of vaporization of the steam as it condenses is transferred through the heat transfer surface into the remaining portion 446b of the wash-water stream 446 to heat and partially vaporize the remaining portion 446b of the wash-water stream 446 entering the reboiler 454. After the steam stream 428 has partially vaporized the remaining portion 446b of the wash-water stream 446, a steam-condensate stream 430 exits the reboiler 454 via a steam-condensate line.

Turning now to FIG. 5, the hydrocarbon conversion system 500 for converting gaseous light hydrocarbons into heavier hydrocarbons is illustrated, according to one embodiment. The water-washed syngas stream 410—having a pressure of between about 350 psig to about 600 psig, and in some embodiments, a pressure between about 400 psig and about 450 psig, and a temperature between about 80° F. (26° C.) and 160° F. (72° C.), and in some embodiments between about 100° F. (37° C.) and about 120° F. (49° C.)—is fed into a lower portion of a first-stage Fischer-Tropsch reactor 510a (first-stage FTR). In the illustrated embodiment, the first-stage FTR 510a is a slurry bubble column reactor wherein the water-washed syngas stream 410 is partially converted into heavier hydrocarbons as the syngas stream flows up within the first-stage FTR 510a. The heavier hydrocarbons derived from the Fischer-Tropsch reaction may range from methane to high molecular weight paraffinic waxes containing more than one-hundred carbon atoms. In alternative embodiments, however, the first-stage FTR 510a may be a fixed bed, ebullating bed, fluidized bed, continuously stirred tank reactor, or any other suitable reactor.

In general, the slurry process in a slurry bubble reactor involves introducing the water-washed syngas stream 410 into a hot, reactive slurry located within the first-stage FTR 510a. The slurry includes Fischer-Tropsch product hydrocarbons (e.g., wax) and particulate Fischer-Tropsch catalyst. A portion of the Fischer-Tropsch product hydrocarbons are liquid at the reactor conditions so that the Fischer-Tropsch catalyst particles are dispersed therein, forming the slurry. The Fischer-Tropsch catalyst particles may be a standard Fischer-Tropsch catalyst as is known in the art. Fischer-Tropsch catalysts include those based upon, for example, cobalt, iron, ruthenium as well as other Group VIIIB transition metals or combinations of such metals for use in preparing both saturated and unsaturated hydrocarbons.

The Fischer-Tropsch catalyst may also include a support such as a metal-oxide support. Potential metal-oxide supports include, but are not limited to, silica, alumina, silica-alumina, or titanium oxides. For example, a cobalt catalyst on transition alumina with a surface area of approximately 100 m²/g to approximately 200 m²/g may be used in the form of spheres being approximately 50 μm to approximately 150 μm in diameter. The cobalt concentration on the support may be between about 5 wt % to about 30 wt %. Catalyst stabilizers and promoters may also be used within the slurry bubble reactor. The catalyst stabilizers include Group IIA or Group IIIB metals, while the promoters may include elements from Group VIII or Group VIIB.

The first-stage FTR 510a includes a cooling coil 514a for removing the heat of reaction resulting from the conversion of the water-washed syngas stream 410 into heavier hydrocarbons. By removing the excess heat created within the first-stage FTR 510a, the first-stage FTR 510a can be operated at a near constant temperature. The heat from the reaction is absorbed by the cooling coil 514a by feeding a water stream 518a having a temperature of about 10° F. (−12° C.) to about 50° F. (10° C.) less than the average temperature of the FTR 510a. The water stream 518a is fed in a lower portion of the first-stage FTR 510a. The surface area and number of tubes forming the cooling coil 514a within the first-stage FTR 510a can vary depending on the temperature of the water stream 518a to be fed into the first-stage FTR 510a and the reaction temperature desired within the first-stage FTR 510a. By increasing the surface area or number of tubes forming the cooling coil 514a, the amount of heat absorption within the first-stage FTR 510a can be increased. The absorbed heat converts the water stream 518a entering the first-stage FTR 510a into a steam stream 522a that exits an upper portion of the first-stage FTR 510a.

The steam stream 522a is fed into a steam drum 526a where a steam exhaust stream 530a is allowed to exit the system. The steam exhaust stream 530a may be utilized elsewhere within the overall process, wherever steam is required, or may be exhausted from the system entirely. The BFW stream 338 is fed to the steam drum 526a as a substitute for the exhausted steam. The BFW stream 338 and any condensation from the steam stream 522a exits a lower portion of the steam drum 526a and is fed to the lower portion of the first-stage FTR 510a by a circulation pump 534a.

As the water-washed syngas stream 410 moves upward within the first-stage FTR 510a, a portion of the syngas is converted into heavier hydrocarbons. As discussed above, a portion of the heavier hydrocarbons produced within the first-stage FTR 510a are liquid (e.g., wax) at the operating conditions of the first-stage FTR 510a. The liquids typically include the heaviest of the converted hydrocarbons and can be withdrawn from the first-stage FTR 510a through a filter. The filter may be a side-arm filter 540a located external from the first-stage FTR 510a or, in alternative embodiments, may be within the first-stage FTR 510a itself.

In the illustrated embodiment, the side-arm filter 540a is attached to the first-stage FTR 510a via a wax conduit 544a. The wax conduit 544a allows the liquid hydrocarbons to exit the first-stage FTR 510a and be filtered out by the side-arm filter 540a. The side-arm filter 540a operates utilizing the natural circulation—from a top portion to a bottom portion—of the liquid hydrocarbons within the first-stage FTR 510a. This natural circulation is induced by the density difference between the three-phase reactor mixture (e.g., wax-catalyst-syngas) and the degassed wax-catalyst slurry.

The side-arm filter 540a is utilized to separate the liquid hydrocarbon product from the first-stage FTR 510a slurry. The slurry is returned to a lower portion of the first-stage FTR 510a via a slurry-return conduit 546a. A separated, heavy-hydrocarbon product stream 548a exits the side-arm filter 540a of the first-stage FTR 510a. The separated, heavy-hydrocarbon product stream 548a is removed from the hydrocarbon conversion system 500 and may be further processed as desired.

An overhead stream 552a exits the first-stage FTR 510a and is cooled by an air cooler 556a in the illustrated embodiment. The overhead stream 552a typically contains produced hydrocarbons (in gaseous form) as well as un-reacted gases such as carbon monoxide and hydrogen. The overhead stream 552a may further include inert gases (e.g., carbon monoxide and nitrogen) in addition to water vapor. The overhead stream 552a exits the first-stage FTR 510a at a temperature between about 400° F. (204° C.) and about 450° F. (233° C.) and is cooled by the air cooler 556a to a temperature of about 150° F. (65° C.) to about 90° F. (33° C.). Alternatively, or additionally, a water cooler or other suitable cooler may be utilized to cool the overhead stream 552a to the desired temperature.

The cooling of the overhead stream 552a causes some of the hydrocarbons and water vapor to condense out of the overhead stream 552a. A resultant three-phase stream 558a includes a liquid-hydrocarbon phase, a liquid-water phase, and a vapor phase that typically contains light, gaseous hydrocarbons, un-reacted gases, and inerts. The three-phase stream 558a is fed into a three-phase separator 562a that is adapted to separate the three phases of the three-phase stream 558a.

The three-phase separator 562a may be a horizontal separator, such as the separator illustrated in FIG. 5, or any other suitable separator. The three-phase stream 558a is fed into an inlet (not shown) located in an upper portion of the three-phase separator 562a. The three-phase separator 562a may include a momentum absorber at the inlet to redirect the three-phase stream 558a, thus, dissipating a portion of the energy of motion of the three-phase stream 558a.

The three-phase stream 558a is temporarily collected within the three-phase separator 562a. The liquid-water phase and the liquid-hydrocarbons phase collect in a lower portion of the three-phase separator 562a while the vapor phase collects in an upper portion. The liquid-water phase of the three-phase stream 558a collects at the bottommost portion 566a of the three-phase separator 562a while the liquid hydrocarbons phase is suspended atop the liquid water. The liquid water exits from the bottommost portion 566a of the three-phase separator 562a forming a process water stream 570a.

The three-phase separator 562a utilizes a spillover weir 568a to separate the liquid hydrocarbon phase from the liquid water phase. As the hydrocarbon liquids accumulate, the liquid level within the three-phase separator 562a raises. Once the liquid level reaches a predetermined height, the liquid hydrocarbons phase begins to spill over the spillover weir 568a and exits the three-phase separator 562a forming a light-hydrocarbons stream 574a. The light-hydrocarbons stream 574a can then be removed from the hydrocarbon conversion system 500 for further processing. The light-hydrocarbons stream 574a and the separated, heavy-hydrocarbon product stream 548a may be processed together or separately depending on the objectives and products desired.

The remaining phase, the vapor phase, is demisted to remove any liquid droplets from the vapor phase. The demisted vapor exits an overhead portion of the three-phase separator 562a to form a vapor stream 578. The vapor stream 578 has a composition similar to that of the water-washed syngas stream 410, except the percentage of the various components within the vapor stream 578 differ from the water-washed syngas stream 410. For example, the percentages of carbon monoxide and hydrogen gas within the vapor stream 578 are typically much lower than their respective percentages in the water-washed syngas stream 410. The vapor stream 578 is then fed into a lower portion of a second-stage FTR 510b.

The second-stage FTR 510b operates in a substantially similar manner as the first-stage FTR 510b. The second-stage FTR 510b includes a cooling coil 514b for removing the heat of reaction resulting from the conversion of the vapor stream 578 into heavier hydrocarbons. The heat from the reaction is absorbed by the cooling coil 514b by feeding a water stream 518b into a lower portion of the second-stage FTR 510b and through the cooling coil 514b. The water stream 518b is heated until it reaches its boiling point and then begins to boil and the latent heat of vaporization removes the heat of reaction. The steam pressure may be controlled to control the boiling point of the water stream 518b within the cooling coil 514b. The steam pressure is adjusted to control the temperature of the cooling coil 514b and maintain a temperature differential of about 10° F. (−12° C.) to about 50° F. (10° C.) below the reactor temperature. The higher the temperature difference between the steam temperature and the reactor temperature, the greater the driving force for the heat transfer and can reduce the heat transfer area that is required. The absorbed heat converts the water stream 518b into a steam stream 522b that exits an upper portion of the second-stage FTR 510b.

The steam stream 522b is fed into a steam drum 526b where a steam exhaust stream 530b is allowed to exit the system. The BFW stream 338 is fed to the steam drum 526b as a substitute for the exiting steam exhaust stream 530a. The BFW stream 338 and any condensation from the steam stream 522b exit a lower portion of the steam drum 526b and are fed to the lower portion of the second-stage FTR 510b by a circulation pump 534b.

As the vapor stream 578 moves upward within the second-stage FTR 510b, a portion of the remaining carbon monoxide and hydrogen gas is converted into hydrocarbons. A wax can be withdrawn from the second-stage FTR 510b through a side-arm filter 540b attached to the second-stage FTR 510b via a wax conduit 544b. The side-arm filter 540b separates the liquid hydrocarbon products from the second-stage FTR 510b slurry. The slurry is returned to a lower portion of the second-stage FTR 510b via a slurry-return conduit 546b. A separated, heavy-hydrocarbon product stream 548b exits the side-arm filter 540b of the second-stage FTR 510b. The separated, heavy-hydrocarbon product stream 548b is removed from the hydrocarbon conversion system 500 along with the separated, heavy-hydrocarbon product stream 548a. The heavy-hydrocarbon streams 548a-b are comprised primarily of C₂₂₊ paraffins.

An overhead stream 552b exits the second-stage FTR 510b and is cooled by an air cooler 556b in the illustrated embodiment. The overhead stream 552b typically contains the produced heavier hydrocarbons (in gaseous form) as well as un-reacted gases such as carbon monoxide and hydrogen. The overhead stream 552b may further include inert gases (e.g., carbon monoxide and nitrogen) in addition to water vapor. The overhead stream 552b exits the second-stage FTR 510b at a temperature between about 400° F. (204° C.) and about 450° F. (233° C.) and is cooled, in the illustrated embodiment, by the air cooler 556b to a temperature of about 150° F. (65° C.) to about 90° F. (33° C.).

The cooling of the overhead stream 552b causes some of the hydrocarbons and water vapor to condense out of the overhead stream 552b. A resultant three-phase stream 558b includes a liquid-hydrocarbons phase, a liquid-water phase, and a vapor phase that typically contains light, gaseous hydrocarbons, un-reacted gases, and inerts. The three-phase stream 558b is fed into a three-phase separator 562b that is adapted to separate the three phases of the three-phase stream 558b.

The three-phase stream 558b is fed into an inlet (not shown) located in an upper portion of the three-phase separator 562b. The three-phase stream 558b is temporarily collected within the three-phase separator 562b. The liquid-water phase and the liquid-hydrocarbons phase collect in a lower portion of the three-phase separator 562b while the vapor phase collects in an upper portion. The liquid-water phase of the three-phase stream 558b collects at the bottommost portion 566b of the three-phase separator 562b while the liquid-hydrocarbons phase is suspended atop the liquid water. The liquid water exits from the bottommost portion 566b of the three-phase separator 562b forming a process water stream 570b that exits the hydrocarbon conversion system 500 along with the process water stream 570a.

The three-phase separator 562b utilizes a spillover weir 568b to separate the liquid-hydrocarbons phase from the liquid-water phase. As the light-hydrocarbon liquids accumulate, the liquid level within the three-phase separator 562b raises. Once the liquid level reaches a predetermined height, the liquid-hydrocarbons phase begins to spill over the spillover weir 568b and exit the three-phase separator 562b forming a light-hydrocarbons stream 574b. The light-hydrocarbons stream 574b is mixed with the light-hydrocarbons stream 574a and exits the hydrocarbon conversion system 500 for further processing. The light-hydrocarbons streams 574a-b are comprised primarily of C₄ to C₂₂ paraffins.

The remaining phase, the vapor phase, is demisted to remove any liquid droplets from the vapor phase. The demisted vapor exits an overhead portion of the three-phase separator 562b to form a tail-gas stream 582. The tail-gas stream 582 has a composition similar to that of the vapor stream 578, except the percentage of the various components within the tail-gas stream 582 differ from the vapor stream 578. For example, the percentages of carbon monoxide and hydrogen gas within the vapor stream 578 are typically much lower than their respective percentages in the vapor stream 578. The tail-gas stream 582 exits the hydrocarbon conversion system 500 and may be discarded or utilized further as desired.

While the present invention has been described with reference to one or more particular embodiments, those skilled in the art will recognize that many changes may be made thereto without departing from the spirit and scope of the present invention. Each of these embodiments and obvious variations thereof is contemplated as falling within the scope of the claimed invention, which is set forth in the following claims.

1. A system for removing sulfur contaminants from an air stream prior to feeding the air stream to an autothermal reformer, comprising:
an air inlet adapted to allow atmospheric air to enter therethrough, the entering atmospheric air forming the air stream;
an air compressor adapted to compress the air stream to a pressure greater than atmospheric pressure;
at least one furnace adapted to heat the air stream to a temperature greater than atmospheric temperature;
a first desulfurization reactor including a first fixed bed, the first fixed bed comprising one or more metal oxides, the one or more metal oxides being adapted to remove sulfur dioxide from the air stream to create a desulfurized air stream, the sulfur dioxide being removed from the air stream as the air stream moves through the first desulfurization reactor; and
the autothermal reformer adapted to receive the desulfurized air stream and a desulfurized natural gas/steam stream and convert the received desulfurized air stream and the received desulfurized natural gas/steam stream into a synthesis gas stream substantially free of sulfur contaminants.

2. The system of claim 1 further comprising a second desulfurization reactor including a second fixed bed, the second fixed bed comprising one or more metal oxides, the one or more metal oxides of the second fixed bed being adapted to remove sulfur dioxide from the air stream to create the desulfurized air stream, the sulfur dioxide being removed from the air stream as the air stream moves through the second desulfurization reactor.

3. The system of claim 2, wherein the first and second desulfurization reactors are placed in a lead-lag arrangement, wherein at any given time one of the first and second desulfurization reactors is a lead desulfurization reactor and the other is a lag desulfurization reactor, such that the sulfur dioxide is removed from the air stream as the air stream moves through the lead desulfurization reactor.

4. The system of claim 3, wherein the lag desulfurization reactor includes either the first fixed bed or the second fixed bed, and wherein the fixed bed of the lag desulfurization reactor is regenerated while the lead desulfurization reactor is removing sulfur dioxide from the air stream.

5. The system of claim 3, wherein the lag desulfurization reactor includes either the first fixed bed or the second fixed bed, and wherein the fixed bed of the lag desulfurization reactor is dumped and recharged while the lead desulfurization reactor is removing sulfur dioxide from the air stream.

6. The system of claim 1, wherein the air compressor is adapted to compress the air stream to greater than 150 psig prior to the air stream moving through the first desulfurization reactor.

7. The system of claim 1, wherein the at least one furnace is adapted to heat the air stream to greater than 750° F. prior to the air stream moving through the first desulfurization reactor.

8. The system of claim 1, wherein the one or more metal oxides of the first fixed bed is copper oxide.

9. The system of claim 1, wherein the one or more metal oxides of the first fixed bed is zinc oxide.

10. The system of claim 1, wherein the one or more metal oxides of the first fixed bed includes both copper oxide and zinc oxide.

11. The system of claim 10, wherein the first fixed bed further comprises an alumina support on which both the copper oxide and zinc oxide are dispersed.

12. The system of claim 1, wherein the air stream has an oxygen level of at least 20% by volume.

13. The system of claim 1, wherein the air stream is an oxygen-enriched air stream.

14. A method for inhibiting sulfur contaminants within a synthesis gas, the method comprising:
removing sulfur contaminants from a natural-gas stream by feeding the natural-gas stream into a gas desulfurization reactor, the gas desulfurization reactor adapted to convert the sulfur contaminants into hydrogen sulfide, and then feeding a resultant hydrogen-sulfide containing natural-gas stream into a hydrogen-sulfide removal system resulting in a desulfurized natural-gas stream;
removing sulfur dioxide from an air stream by feeding the air stream into a desulfurization reactor including a fixed bed, the fixed bed comprising at least one metal oxide, the at least one metal oxide being adapted to remove sulfur dioxide from the air stream to create a desulfurized air stream, the sulfur dioxide being removed from the air stream as the air stream moves through the desulfurization reactor resulting in a desulfurized air stream; and
providing the desulfurized air stream and the desulfurized natural-gas stream along with steam to an autothermal reformer adapted to convert the desulfurized air stream, the desulfurized natural-gas stream, and the steam into a synthesis gas.

15. The method of claim 14, wherein the air stream is formed by allowing atmospheric air to enter an air inlet.

16. The method of claim 14, wherein the air stream has an oxygen level of at least 20% by volume.

17. The method of claim 14, wherein the at least one metal oxide of the fixed bed is copper oxide.

18. The method of claim 14, wherein the at least one metal oxide of the fixed bed is zinc oxide.

19. The method of claim 14, wherein the fixed bed comprises an alumina support upon which both copper oxide and zinc oxide are dispersed.

20. The method of claim 14 further comprising providing the synthesis gas to at least one Fischer-Tropsch reactor.

21. The method of claim 20, wherein the at least one Fischer-Tropsch reactor is a slurry bubble column reactor including at least one Fischer-Tropsch catalyst.

22. The method of claim 14, wherein the air stream is an oxygen-enriched air stream.
